(19) United States
(12) Patent Application Publication
(10) Pub. No.: US 2010/0289187 A1
(43) Pub. Date: Nov. 18, 2010

(54) Film for insert injection molding and insert injection molding method using the same

(75) Inventors: Ah Hyun BAE, Hwaseong-si (KR); Yong Seung SHIN, Hwaseong-si (KR); Ki Yul LIM, Suwon-si (KR); Young Min KIM, Seongnam-si (KR); Geun Ho LEE, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd

(21) Appl. No.: 12/662,107

(22) Filed: Mar. 31, 2010

(30) Foreign Application Priority Data
May 15, 2009 (KR) 10-2009-0042633

(51) Int. Cl. B29C 35/08; B32B 15/08; B29C 45/14; B22D 11/126

(52) U.S. Cl. 264/447; 428/457; 264/271.1; 29/527.1

(57) ABSTRACT

Disclosed herein are a film for insert injection molding and an insert injection molding method using the same. The film has a symmetrical structure about a thin metallic base film. Such a structure realizes superior appearance and reliability.

### CROSS-REFERENCE TO RELATED APPLICATIONS

This application claims priority under 35 U.S.C. §119 to Korean Patent Application No. 2009-0042633, filed on May 15, 2009 in the Korean Intellectual Property Office (KIPO), the entire disclosure of which is incorporated herein by reference in its entirety.

### BACKGROUND

1. Field

Example embodiments relate to a film for insert injection molding and an insert injection molding method using the same.

2. Description of the Related Art

The demand for improved metal texture and the manufacture of new materials and surface-treatment techniques to realize the improved metal texture is increasing. In response to this demand, product designers design molded metal articles with superior texture on the exterior of products.

However, molded metal articles have limitations of low formation and design flexibility. In addition, molded metal articles have disadvantages of higher weight and high cost of improved metallic texture due to higher costs of raw materials.

Accordingly, products wherein surface-treatment such as deposition is performed on a resin-molded article are suggested to solve problems associated with molded metal articles. Such a product may have a lower cost and have a metallic texture. But, because the product is not made of a metal, the product fails to have improved superior texture as required by designers and consumers. In particular, the product manufacture involves unstable deposition processes, thus creating problems associated with adhesion and reliability of molded articles.

### SUMMARY

According to an example embodiment, a film for insert injection molding may include a base film made of a metal; a first resin film layer laminated on a side of the base film; and a second resin film layer laminated on a side of the base film opposite to the side having the first resin film layer.

According to an example embodiment, the film may further include a first adhesion layer configured to adhere the base film to the first resin film layer; and a second adhesion layer configured to adhere the base film to the second resin film layer.

According to an example embodiment, the film for insert injection molding has a symmetrical structure about the base film.

The film, according to an example embodiment, may further include a hard coating layer on the first resin film layer. The hard coating layer may be configured to prevent scratching and abrasion of the first resin film layer.

According to an example embodiment, the film may include a resin adhesion layer on the second resin film layer. The resin adhesion layer may be configured to adhere the film to an injection resin and is of a same material as, the hard coating layer.

According to example embodiments, the first and second resin film layers may include at least one of polyethyleneterephthalate (PET), polycarbonate (PC), polyvinyl chloride (PVC) and polyurethane (PU) and mixtures thereof.

According to another example embodiment, the film may include a printing layer disposed below the first resin film layer such that the printing layer is in contact with the hard coating layer.

According to an example embodiment, the base film may be of at least one of aluminum, titanium, gold, nickel, chromium and copper, the first and second resin film layers may be of polyethyleneterephthalate (PET), polycarbonate (PC), polyvinyl chloride (PVC), polyurethane (PU) or mixtures thereof, the hard coating layer is at least one of a UV-curing resin, a thermoplastic resin and a thermosetting resin, and the resin adhesion layer is of at least one of a UV-curing adhesive, a thermoplastic adhesive and a thermosetting adhesive.

According to an example embodiment, the hard coating layer may be the uppermost layer of the film and the resin adhesion layer may be the lowermost layer of the film.

According to an example embodiment, the hard coating layer is at least one of a thermosetting resin, a thermo plastic resin and a UV-curing resin.

According to an example embodiment, an insert injection molding method may include preparing a film for insert injection molding, the film including first and second resin film layers, and placing the film into a mold, injecting an injection resin into the mold and performing injection-molding to obtain an integrated injected article. The first and second resin film layers may be arranged on opposite sides of a thin metallic base film, and may be made of a same material.

According to an example embodiment, the method may further include forming a desired shape of the film for insert injection molding, and trimming an unnecessary portion of the film.

According to an example embodiment, the preparation of the film for insert injection molding may include forming a hard coating layer as the uppermost layer of the film by UV-curing or thermosetting coating; and forming a resin adhesion layer as the lowermost layer of the film, the resin adhesion layer adhering the film to an injected article.

According to an example embodiment, the method may include contacting a sidewall of the film for insert injection molding with the injected article.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a sectional view illustrating a film for insert injection molding according to an example embodiment;

FIG. 2 is a sectional view illustrating a film for insert injection molding according to another example embodiment;

FIG. 3 is a process view illustrating a method of manufacture of a film for insert injection molding, according to an example embodiment;

FIG. 4 is a flow chart illustrating the example method of manufacture of a film for insert injection molding;

FIG. 5 is a flow chart illustrating a method of manufacture of a film for insert injection molding according to another example embodiment;

FIG. 6 is a process view illustrating an insert injection method using the film for insert injection molding according to an example embodiment; and

FIG. 7 is a sectional view illustrating a portion of a molded article manufactured by the insert injection method according to an example embodiment.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

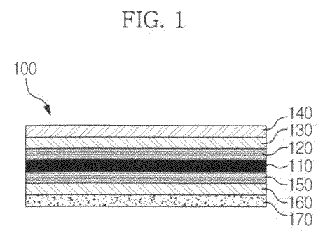

FIG. 1 is a sectional view illustrating a film for insert injection molding according to an example embodiment.

Insert molding is a process of obtaining an integrated molded article by molding a film or sheet of material into a three-dimensional shape using vacuum molding, removing unnecessary film or sheet of material, injecting the remaining film or sheet of material into an injection mold and injection-molding a resin as a base material into the mold.

The film for insert injection molding is inserted into an injection mold, injection-molded together with an injection resin and adhered to the external surface of the injected article to impart superior texture to the surface of the article.

For example, the film is provided on cases for cellular phones, computers, or panels for washing machines, display devices, for ornamental effects with a variety of colors and patterns.

According to an example embodiment illustrated in FIG. 1, a film used in insert injection molding 100 may include a base film 110 of a metal, a first adhesion layer 120 disposed/laminated on one side of the base film 110, a first resin film layer 130 disposed/laminated on the first adhesion layer 120 order, a second adhesion layer 150 disposed/laminated on a side opposite to the side of the base film 110 having the first resin layer 130 and a second resin film layer 160 disposed/laminated on the second adhesion layer 150.

In this manner, the first and second adhesion layers 120 and 150, which may be made of a same material, and the first and second resin film layers 130 and 160, which may also be made of a same material, are disposed/laminated on both sides of the metallic base film 110. Such an arrangement may prevent the film 100 from being bent due to a difference in amount of contraction between the metallic base film 110 and the resin film layers 130 and 160 caused by heat during injection-molding.

The resin film layers 130 and 160 support the metallic base film 110 made of a thin metal film to reproduce a metallic texture and form patterns.

In addition, a hard coating layer 140 to prevent scratch and abrasion is disposed/laminated on the first resin film layer 130 and a resin adhesion layer 170 to adhere the film 100 to an injected article is disposed/laminated on the second resin film layer 160.

The resin adhesion layer 170 may be made of a same material as the hard coating layer 140. As a result, the film 100 has a symmetrical structure about the thin metallic base film 110 and such a symmetrical structure may prevent deformation of the film 100.

According to example embodiment, the film 100 has a structure, wherein a thin metallic base film 110 is interposed in the center of the film 100, the adhesion layers 120 and 150 that are made of a same material, and the resin film layers 130 and 160 that are made of a same material are laminated at opposite sides of the thin metallic base film 110. The resin adhesion layer 170 may be disposed/laminated as a lowermost layer of the thin metallic base film 110 and the hard coating layer 140 may be disposed/laminated as an uppermost layer of the thin metallic base film 110. The resin adhesion layer 170 and the hard coating layer 140 may be made of a same material. As mentioned previously, such a structure may prevent bending-deformation of the film 100 due to a difference in contraction ratio between metals and resins during injection molding.

Additionally, the thin metallic base film 110 may reproduce original texture of natural materials, thereby decreasing product weight, preventing deterioration in metallic texture upon deposition or ink-printing, and rendering improved texture.

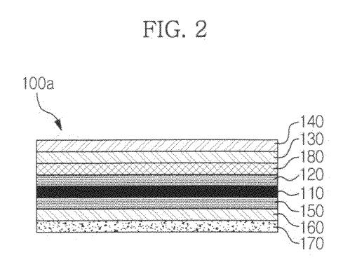

FIG. 2 is a sectional view illustrating a film for insert injection molding according to another example embodiment.

According to the example embodiment illustrated in FIG. 2, a film for insert injection molding 100a may include a printing layer 180 in addition to the layers of the film 100. The film 100a may include a variety of shapes, patterns and colors that may render metallic effects.

As shown in FIG. 2, the printing layer 180 may be provided below the first resin film layer 130 by Gravure or silk-screen printing or the like.

The printing layer 180 may be protected by the hard coating layer 140 and the first resin film layer 130, thus avoiding color variation upon boil resistance tests or deformation due to abrasion of the film 100a.

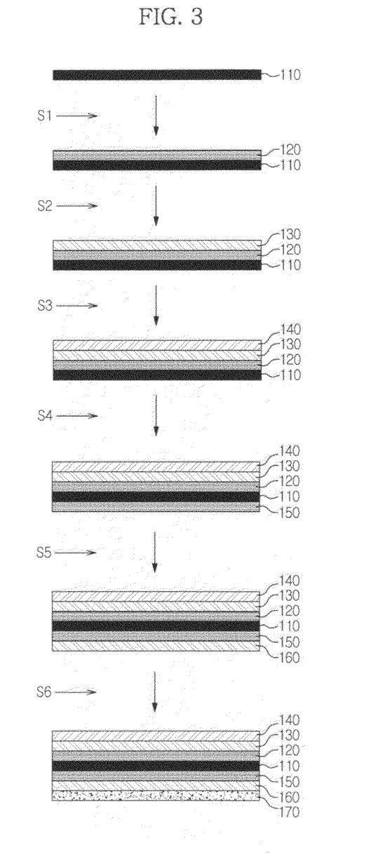

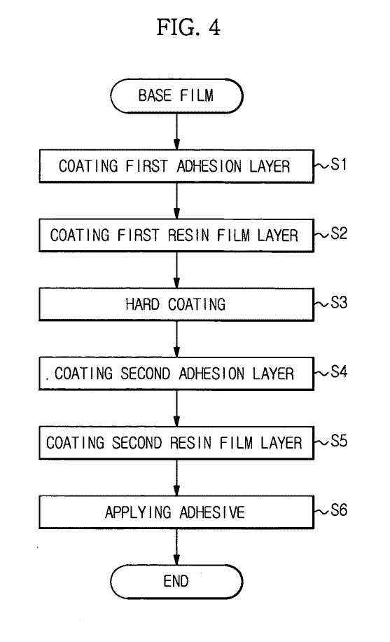

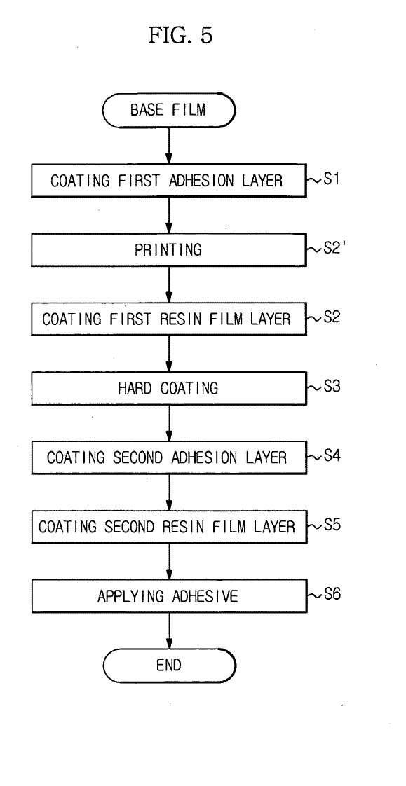

Hereinafter, a method of manufacture of a film for insert injection molding according to an example embodiment will be described. FIGS. 3 and 4 respectively illustrate a process view and a flow chart of a method of manufacturing a film for insert injection molding. FIG. 5 is a flow chart illustrating a method for manufacturing a film for insert injection molding according to another example embodiment.

As shown in FIGS. 3 and 4, the method of manufacture of the film for insert injection molding may include coating a first adhesion layer on a base film 110 (S1); coating a first resin film layer (S2); hard coating (S3); coating a second adhesion layer (S4); coating a second resin film layer (S5); and applying an adhesive (S6).

The base film 110 may be a thin film made of a metal selected from Ti, Al, Au, Ni, Cr and Cu.

The thin metallic base film 110 may have a suitable thickness depending on a value R (Radius of curvature) of a curved surface to prevent the film 100 from being detached from the curved surface during a process of pre-forming for molding the film 100 into an approximately three-dimensional shape for insert injection molding.

The process of coating a first adhesion layer (S1) is carried out by coating an adhesive on the thin metallic base film 110 to adhere the thin metallic base film 110 to the first resin film layer 130.

The adhesive may be selected from heat-reactive adhesives, such as hot melt adhesives with superior adhesion strength with synthetic resins and metals, synthetic resin-based adhesives, acrylic resins-based adhesives and rubber-based adhesives and primers for instant adhesives.

The process for coating a first resin film layer (S2) is carried out by coating a first resin film layer 130 on the first adhesion layer 120. The first resin film layer 130 may be a film made of a material selected from synthetic resins including polyethyleneterephthalate (PET), polycarbonate (PC), polyvinyl chloride (PVC) and polyurethane (PU) and mixtures thereof. In particular, the PET film with relatively high heat resistance and hardness is generally used for the first resin film layer 130.

The first resin film layer 130 may be used as a base for forming the printing layer 180. The method of manufacture of the film 100a (FIG. 2) including the printing layer 180 may additionally include a printing process to form the printing layer 180 below the first resin film layer 130 (S2′ in FIG. 5).

The printing (S2′) may lead to formation of various colored designs below the first resin film layer 130 by a conventional printing method such as screen or Gravure printing or the like.

In the process of hard coating (S3), a hard coating composition to prevent scratching or abrasion of the first resin film layer 130 is coated thereon to form a hard coating layer 140.

The hard coating composition constituting the hard coating layer 140 may utilize a resin with superior strength and coatability, and may be, for example, a thermosetting resin, a thermoplastic resin or a UV-curing resin. Preferably, UV-curing resins which have relatively higher solvent-resistance and weldability and that may form the hard coating layer 140 in a relatively simple manner may be used.

Accordingly, a hard coating composition including a UV-curing resin, a photo-initiator and an organic solvent is applied on the first resin film layer 130 and then cured by UV irradiation, to form the hard coating layer 140 via UV coating.

The process of coating the second adhesion layer (S4) may include adhering the thin metallic base film 110 to the second resin film layer 160 and is carried out by coating an adhesive similar to the first adhesion layer 120 on a side of the thin metallic base film 110 opposite to the side having the first resin film layer 130. The process for coating the second adhesion layer (S4) is somewhat similar to the process for coating the first adhesion layer (S1), except that the second adhesion layer is applied on the opposite side of the thin metallic base film 110.

The process of coating the second resin film layer (S5) is carried out by coating the second resin film layer of a material somewhat similar to the first resin film layer 130 on the second adhesion layer 150 and is somewhat similar to the process for coating the first resin film layer 130 (S2).

In the process of coating an adhesive (S6), an adhesive is applied on the second resin film layer 160 to form a resin adhesion layer 170. The resin adhesion layer 170 may improve adhesive strength between the film 100 and an injection-molded article.

Examples of adhesives that can be used for formation of the resin adhesion layer 170 include, but are not limited to, thermoplastic synthetic resin-based adhesives, thermosetting acrylic-based resin adhesives, UV-curing adhesives or the like.

The resin adhesion layer 170 may be made of a material somewhat similar to the hard coating layer 140. For example, when the hard coating layer 140 of the film 100 is made of a UV-curing adhesive, the resin adhesion layer 170 may also be formed using the UV-curing adhesive.

In one example embodiment, a UV curing acrylic adhesive which adheres by radical polymerization may be used as the adhesive. Herein, a primer, which utilizes highly-pure epoxy acrylate as a reactive oligomer, has a transparency of 93% and is supplemented with benzoinether as a photo-polymerization initiator, is applied and then cured by photo-polymerization via irradiation at near ultra-violet wavelengths of 200 to 400 nm.

Hereinafter, an insert injection method using the film 100 according to an example embodiment will be described.

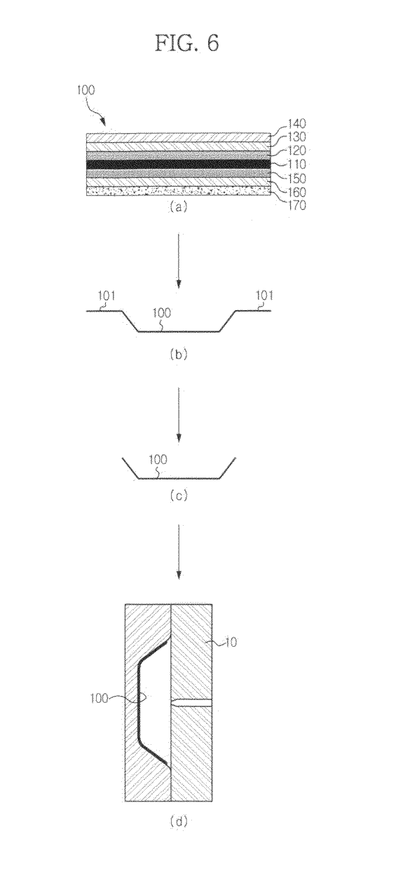

FIG. 6 is a process view illustrating an insert injection method using, the film for insert injection molding according to an example embodiment.

As shown in FIG. 6, the insert injection method may include (a) preparing a film 100, (b) forming the film 100, (c) trimming away the edges of the film 100, and (d) inserting the film 100 into the mold and injecting an injection resin into the resulting mold to perform injection molding.

The preparation of the film 100 (a) is carried out by preparing the film 100 having a symmetrical structure about the thin metallic base film 110 according to the example method illustrated in FIG. 3.

The thickness of the base film 110 and the film 100 can be suitably determined, depending on a corner R of the formed curved surface of the injected article, so as to prevent the base film 110 from being broken due to the difference in elongation during the process of forming (b) to mold the film 100 into a three-dimensional shape. The corner R may be a radius of curvature of a corner of the curved surface of the injected article.

For example, when the thin metallic base film 110 is an aluminum metal thin film, the thickness of the base film 110 is 40 μm or less (R≦2.5 mm), 30 μm or less (2.5<R<4 mm), 20 μm or less (4≦R<5 mm) and 10 μm or less (R≧5 mm).

In addition, the film for insert injection molding 100 has a suitable thickness depending on the size of products. For example, when the film 100 is used in small mobile products, the film 100 may have a thickness of about 150 μm or less, and when the film 100 is used in medium/large products, the film 100 may have a thickness of about 120 μm or higher.

In the process of forming (b), the film 100 may be formed by hot-forming such as press molding or vacuum forming or the like, to provide a three-dimensional (3D) shape to the film 100.

When the press molding or vacuum forming is used, an additional heater may be provided to heat the film 100 to a temperature suited to the thickness of the base film 110.

For example, when the thin metallic base film 110 is an aluminum thin film and has a thickness of 40 μm or less, the film 100 is molded at 120° C. or less, when the thin metallic base film 110 has a thickness of 30 μm or less, the film 100 is molded at 100 to 130° C., when the thin metallic base film 110 has a thickness of 20 μm or less, the film 100 is molded at 90 to 110° C., and when the thin metallic base film 110 has a thickness of 10 μm or less, the film 100 is molded at 70 to 100° C.

In the process of trimming (c), an unnecessary edge 101 of the film 100 pre-molded by the forming process is removed by press or laser processing.

In the process of injection-molding (d), the film 100 is placed in an injection mold 10 and an injection resin is injected into the mold 10 to obtain a molded article, wherein the film 100 and the injected resin are integrated together.

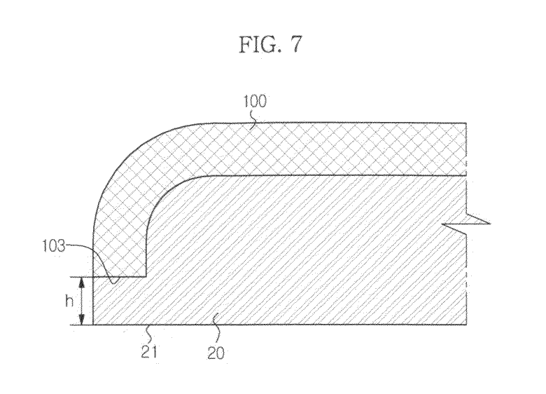

As shown in FIG. 7, the injection mold may be manufactured such that a sidewall end 103 of the film 100 comes in contact with the injected resin 20 to prevent the detachment of the film 100 caused by deterioration in an adhesive strength between the injected resin 20 and the film 100 after the insert injection molding of the film 100.

When a height (h) between the bottom 21 of the injected resin 20 and the film 100 is large, deterioration in appearance quality of products may occur. For this reason, the height (h) may be around 1 mm or less.

As is apparent from the foregoing description, the film for insert injection molding 100, according to example embodiments, may utilize a natural metal thin film and thus may reproduce original texture of metals, thereby obtaining a molded article with improved appearance and realizing light-weight products at low cost.

In addition, the film for insert injection molding 100, according to example embodiments, may have a symmetrical structure about the metal thin film, thus minimizing bending deformation of the film upon insert injection molding.

Further, the insert injection molding method using the film for insert injection molding 100, according to example embodiments, results in molded articles by a series of forming, trimming and insert-injection molding techniques, thus improving production efficiency due to reduced costs.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A film for insert injection molding, comprising:
a base film made of a metal;
a first resin film layer laminated on a side of the base film; and
a second resin film layer laminated on a side of the base film opposite to the side having the first resin film layer.

2. The film according to claim 1, further comprising:
a first adhesion layer configured to adhere the base film to the first resin film layer; and
a second adhesion layer configured to adhere the base film to the second resin film layer.

3. The film according to claim 2, wherein the film for insert injection molding has a symmetrical structure about the base film.

4. The film according to claim 3, further comprising:
a hard coating layer on the first resin film layer, the hard coating layer configured to prevent scratching and abrasion of the first resin film layer.

5. The film according to claim 4, further comprising:
a resin adhesion layer on the second resin film layer, wherein the resin adhesion layer configured to adhere the film to an injection resin and is of a same material as the hard coating layer.

6. The film according to claim 3, wherein the first and second resin film layers include at least one of polyethyleneterephthalate (PET), polycarbonate (PC), polyvinyl chloride (PVC) and polyurethane (PU) and mixtures thereof.

7. The film according to claim 5, further comprising:
a printing layer disposed below the first resin film layer such that the printing layer is in contact with the hard coating layer.

8. The film according to claim 5, wherein the base film is of at least one of aluminum, titanium, gold, nickel, chromium and copper, the first and second resin film layers are of at least one of polyethyleneterephthalate (PET), polycarbonate (PC), polyvinyl chloride (PVC) and polyurethane (PU) and mixtures thereof, the hard coating layer is at least one of a UV-curing resin, a thermoplastic resin and a thermosetting resin, and the resin adhesion layer is of at least one of a UV-curing adhesive, a thermoplastic adhesive and a thermosetting adhesive.

9. The film according to claim 5, wherein the hard coating layer is the uppermost layer of the film and the resin adhesion layer is the lowermost layer of the film.

10. The film according to claim 5, wherein the hard coating layer is at least one of a thermosetting resin, a thermo plastic resin and a UV-curing resin.

11. An insert injection molding method, comprising:
preparing a film for insert injection molding, the film including first and second resin film layers, wherein the first and second resin film layers are arranged at opposite sides of a thin metallic base film, and are made of a same material; and
placing the film into a mold, injecting an injection resin into the mold and performing injection-molding to obtain an integrated injected article.

12. The method according to claim 11, further comprising:
forming a desired shape of the film for insert injection molding, and trimming an unnecessary portion of the film.

13. The method according to claim 11, wherein the preparation of the film for insert injection molding comprises:
forming a hard coating layer as the uppermost layer of the film by UV-curing or thermosetting coating; and
forming a resin adhesion layer as the lowermost layer of the film, the resin adhesion layer adhering the film to an injected article.

14. The method according to claim 11, comprising:
contacting a sidewall of the film for insert injection molding with the injected article.
